(19) United States
(12) Patent Application Publication
(10) Pub. No.: US 2013/0044302 A1
(43) Pub. Date: Feb. 21, 2013

(54) Lithographic Apparatus and Method

(71) Applicants: Heine Melle MULDER, Veldhoven (NL); Steven George Hansen, Phoenix, AZ (US); Thijs Johan Henry Hollink, Eindhoven (NL)

(72) Inventors: Heine Melle MULDER, Veldhoven (NL); Steven George Hansen, Phoenix, AZ (US); Thijs Johan Henry Hollink, Eindhoven (NL)

(73) Assignee: ASML Netherlands B.V., Veldhoven (NL)

(21) Appl. No.: 13/550,561

(22) Filed: Jul. 16, 2012

Related U.S. Application Data
(60) Provisional application No. 61/525,460, filed on Aug. 19, 2011.

(51) Int. Cl. G03B 27/54; G03B 27/32

(52) U.S. Cl. 355/67; 355/77

(57) ABSTRACT

A lithographic apparatus includes an illumination system, a patterning device, and a projection system. The illumination system provides a radiation beam. The patterning device imparts the radiation beam with a pattern in its cross-section. The substrate holder holds a substrate. The projection system projects the patterned radiation beam onto a target portion of the substrate. The apparatus is constructed and arranged, at least in use, to image a pattern on to the substrate using radiation having: a bright field intensity distribution in a first direction; and a dark field intensity distribution in second direction, substantially perpendicular to the first direction.

### CROSS REFERENCE TO RELATED APPLICATIONS

This application claims the benefit under 35 U.S.C. §119(e) to U.S. Provisional Patent Application No. 61/525,460, filed Aug. 19, 2011, which is incorporated by reference herein in its entirety.

### BACKGROUND

1. Field of Invention

The invention relates generally to a lithographic apparatus and method.

2. Related Art

A lithographic apparatus is a machine that applies a desired pattern onto a target portion of a substrate. Lithographic apparatus can be used, for example, in the manufacture of integrated circuits (ICs). When so used, a patterning device, which is alternatively referred to as a mask or a reticle, may be used to generate a circuit pattern corresponding to an individual layer of the IC, and this pattern can be imaged onto a target portion (e.g. comprising part of, one or several dies) on a substrate (e.g. a silicon wafer) that has a layer of radiation-sensitive material (resist). In general, a single substrate has a matrix of target portions that are successively exposed. Known lithographic apparatus include so-called steppers, in which each target portion is irradiated by exposing an entire pattern onto the target portion in one go, and so-called scanners, in which each target portion is irradiated by scanning the pattern through the beam in a given direction (the “scanning”-direction) while synchronously scanning the substrate parallel or anti-parallel to this direction.

For some applications, there has been a move in the lithography industry towards the use of relatively simple line and space patterns. Such simple line and space patterns may be produced more easily or more quickly than more complex patterns. In some applications, the pattern may simply comprise a number of lines. However, it is more likely that lines of the pattern are provided with gaps that sever the line.

Conventionally, a line and space pattern is provided using two exposures. In the first exposure the lines and/or spaces of the pattern are provided. A second exposure is then used to provide gaps in those lines (sometimes referred to as “cutting” the lines). This approach is inefficient and impractical. Firstly, two patterning devices (or patterning devices in two separate configurations) are required: one for the provision of the lines and spaces and one for the subsequent provision of gaps in those lines. Secondly, two exposures are required to produce the final overall line and space pattern. Such an approach increases the cost and complexity of the lithographic process as a whole, and also reduces throughput. The requirement for two exposures may also lead to an increase in defects or, at the very least, may lead to or result in increased overlay problems or concerns.

### SUMMARY

It is desirable to provide, for example a lithographic method and/or apparatus (and/or an illumination mode for use in such apparatus or method) that obviates or mitigates one or more of the problems of the prior art, whether identified herein or elsewhere, or which provides an alternative to an existing lithographic method and/or apparatus (or illumination mode).

An embodiment of the invention provides a lithographic apparatus. An illumination system provides a radiation beam. A patterning device imparts the radiation beam with a pattern in its cross-section. A substrate holder holds a substrate. A projection system projects the patterned radiation beam onto a target portion of the substrate. The lithographic apparatus is arranged, at least in use, to image a pattern onto the substrate (for example, in a single exposure) using radiation having: a bright field intensity distribution in a first direction; and a dark field intensity distribution in second direction, substantially perpendicular to the first direction.

The patterning device may be or include an attenuated phase shift mask (which includes reticle and the like) or, more generally, an attenuated phase shift patterning device.

The illumination system may be configured to provide, at least in use (and for example in a single exposure), an illumination mode, the illumination mode comprising radiation having: a bright field intensity distribution in the first direction; and a dark field intensity distribution in the second direction.

The patterning device (or more generally, the pattern) may be configured to provide a substantially line and space pattern to be imaged on the substrate, one or more lines having one or more gaps therein that each sever the line.

One or more (or all) lines may extend along the second direction.

The patterning device (or more generally, the pattern) may be configured such that the one or more gaps are each longer than a width of each of the one or more lines.

The patterning device (or more generally, the pattern) may be configured such that the one or more gaps have a larger pitch and/or are more isolated features than the one or more lines.

The patterning device (or more generally, the pattern) may provide one or more lines having one or more dimensions and/or orientations which result in the one or more lines (e.g. at least the lengths of those lines) being imaged, in use, by the bright field radiation (and specifically, at least in a preferred example, solely by the bright field radiation), and wherein the patterning device (or more generally, the pattern) may provide one or more gaps (which may equate to, or be defined by ends of lines, the ends being perpendicular to the lengths of the lines) having one or more dimensions and/or orientations which result in the one or more gaps being imaged, in use, predominantly by the dark field radiation.

The dark field intensity distribution may have a higher intensity (e.g. cumulatively, for example in or at a pupil plane) than the bright field intensity distribution.

The bright field intensity distribution might form at least a dipole; and/or the dark field intensity distribution might form at least a dipole.

The lithographic apparatus may further include a mask arrangement located downstream of the patterning device, the mask arrangement being configured to mask at least a portion of bright field radiation distributed in the first direction, to ensure that there is dark field radiation distributed in the first direction. The dark field radiation will thus be derived from that portion of the bright field radiation that is masked (i.e. blocked), due to scattering or diffraction or the like of the bright field radiation off a pattern feature of or provided by the patterning device. The masking ensures that at least a portion of the bright field radiation cannot pass through the projection system and on to the substrate, with dark field radiation passing through instead.

An embodiment of the invention provides a lithographic method. A pattern is imaged onto a substrate (for example, in a single exposure) using radiation having: a bright field intensity distribution in a first direction; and a dark field intensity distribution in a second direction, substantially perpendicular to the first direction.

The method may include forming an illumination mode (for example, for the single exposure) including radiation having: a bright field intensity distribution in the first direction; and a dark field intensity distribution in the second direction.

An embodiment of the invention provides an illumination mode (for example, for a single exposure) including radiation having: a bright field intensity distribution in a first direction; and a dark field intensity distribution in a second direction, substantially perpendicular to the first direction.

For the illumination mode, the described intensity distributions may describe the distributions within or at a pupil plane (e.g. of an illuminator, of an illuminator of a lithographic apparatus, or a lithographic apparatus in general).

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 schematically depicts an example of a lithographic apparatus that may implement, or be used to implement the invention.

FIG. 2 schematically depicts an example of a line and space pattern to be provided on a substrate.

FIGS. 3 and 4 schematically depict two different patterning devices (or patterning devices in two different configurations) that are conventionally required to provide the pattern shown in FIG. 2.

FIG. 5 shows an example of a single patterning device (or a patterning device in a single configuration) that may be used to provide the pattern shown in FIG. 2.

FIG. 6 schematically depicts a first illumination mode for use in attempting to provide the pattern of FIG. 2 using the patterning device of FIG. 5.

FIG. 7 schematically depicts a second illumination mode for use in attempting to provide the pattern of FIG. 2 using the patterning device of FIG. 5.

FIG. 8 schematically depicts an illumination mode in accordance with an embodiment of the invention, suitable for providing the pattern of FIG. 2 using the patterning device of FIG. 5.

FIG. 9 schematically depicts one approach to providing dark field illumination in a lithographic apparatus in accordance with an embodiment of the invention.

FIG. 10 schematically depicts a free form illumination mode in accordance with an embodiment of the invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

This specification discloses one or more embodiments that incorporate the features of this invention. The disclosed embodiment(s) merely exemplify the invention. The scope of the invention is not limited to the disclosed embodiment(s). The invention is defined by the claims appended hereto.

The embodiment(s) described, and references in the specification to “one embodiment”, “an embodiment”, “an example embodiment”, etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc.

Before describing such embodiments in more detail, however, it is instructive to present an example environment in which embodiments of the present invention may be implemented.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist) or a metrology or inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

The terms “radiation” and “beam” used herein encompass all types of electromagnetic radiation, including ultraviolet (UV) radiation (e.g. having a wavelength of 365, 248, 193, 157 or 126 nm) and extreme ultra-violet (EUV) radiation (e.g. having a wavelength in the range of 5-20 nm), as well as particle beams, such as ion beams or electron beams.

The term “patterning device” used herein should be broadly interpreted as referring to a device that can be used to impart a radiation beam with a pattern in its cross-section such as to create a pattern in a target portion of the substrate. It should be noted that the pattern imparted to the radiation beam may not exactly correspond to the desired pattern in the target portion of the substrate. Generally, the pattern imparted to the radiation beam will correspond to a particular functional layer in a device being created in the target portion, such as an integrated circuit.

A patterning device may be transmissive or reflective. Examples of a patterning device include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions; in this manner, the reflected beam is patterned.

The support structure holds the patterning device. It holds the patterning device in a way depending on the orientation of the patterning device, the design of the lithographic apparatus, and other conditions, such as for example whether or not the patterning device is held in a vacuum environment. The support can use mechanical clamping, vacuum, or other clamping techniques, for example electrostatic clamping under vacuum conditions. The support structure may be a frame or a table, for example, which may be fixed or movable as required and which may ensure that the patterning device is at a desired position, for example with respect to the projection system. Any use of the terms “reticle” or “mask” herein may be considered synonymous with the more general term “patterning device”.

The term “projection system” used herein should be broadly interpreted as encompassing various types of projection system, including refractive optical systems, reflective optical systems, and catadioptric optical systems, as appropriate for example for the exposure radiation being used, or for other factors such as the use of an immersion fluid or the use of a vacuum. Any use of the term “projection lens” herein may be considered as synonymous with the more general term “projection system”.

The illumination system may also encompass various types of optical components, including refractive, reflective, and catadioptric optical components for directing, shaping, or controlling the beam of radiation, and such components may also be referred to below, collectively or singularly, as a “lens”.

The lithographic apparatus may be of a type having two (dual stage) or more substrate holders (and/or two or more support structures). In such “multiple stage” machines the additional holders may be used in parallel, or preparatory steps may be carried out on one or more holders while one or more other holders are being used for exposure.

The lithographic apparatus may also be of a type wherein the substrate is immersed in a liquid having a relatively high refractive index, e.g. water, so as to fill a space between the final element of the projection system and the substrate. Immersion techniques are well known in the art for increasing the numerical aperture of projection systems.

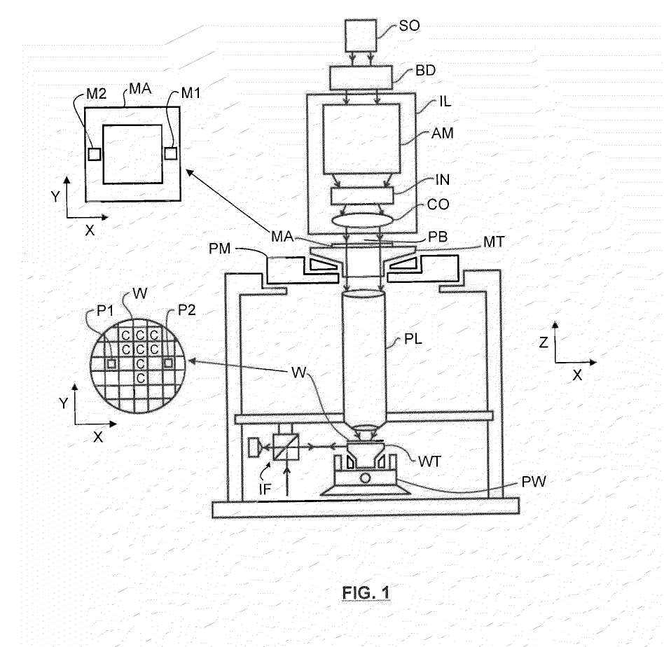

FIG. 1 schematically depicts an example of a lithographic apparatus. The apparatus comprises an illumination system (illuminator) IL to condition a beam PB of radiation (e.g. UV radiation or EUV radiation). A support structure (e.g. a mask table) MT to support a patterning device (e.g. a mask) MA and connected to first positioning device PM to accurately position the patterning device with respect to projection lens PL. A substrate holder (e.g. a wafer table) WT for holding a substrate (e.g. a resist-coated wafer) W and connected to second positioning device PW for accurately positioning the substrate with respect to a projection lens PL. A projection system (e.g. a refractive projection lens) PL configured to image a pattern imparted to the radiation beam PB by patterning device MA onto a target portion C (e.g. comprising one or more dies) of the substrate W.

As here depicted, the apparatus is of a transmissive type (e.g. employing a transmissive mask). Alternatively, the apparatus may be of a reflective type (e.g. employing a programmable mirror array of a type as referred to above).

The illuminator IL receives a beam of radiation from a radiation source SO. The source and the lithographic apparatus may be separate entities, for example when the source is an excimer laser. In such cases, the source may not be considered as forming part of the lithographic apparatus, and the radiation beam is passed from the source SO to the illuminator IL with the aid of a beam delivery system BD comprising for example suitable directing mirrors and/or a beam expander—i.e. the radiation source SO may be in connection with the lithographic apparatus. In other cases the source may be an integral part of the apparatus, for example when the source is a mercury lamp. The source SO and the illuminator IL, together with the beam delivery system BD if required, may be referred to as a radiation system.

The illuminator IL may comprise adjusting means AM for adjusting the angular intensity distribution of the beam. Generally, at least the outer and/or inner radial extent (commonly referred to as a-outer and a-inner, respectively) of the intensity distribution in a pupil plane of the illuminator can be adjusted. In addition, the illuminator IL generally comprises various other components, such as an integrator IN and a condenser CO. The illuminator provides a conditioned beam of radiation PB, having a desired uniformity and intensity distribution in its cross-section.

The radiation beam PB is incident on the patterning device (e.g. mask) MA, which is held on the support structure MT. Having traversed the patterning device MA, the beam PB passes through the projection system PL of a projection system, which focuses the beam onto a target portion C of the substrate W. With the aid of the second positioning device PW and position sensor IF (e.g. an interferometric device), the substrate holder WT can be moved accurately, e.g. so as to position different target portions C in the path of the beam PB. Similarly, the first positioning device PM and another position sensor (which is not explicitly depicted in FIG. 1) can be used to accurately position the patterning device MA with respect to the path of the beam PB, e.g. after mechanical retrieval from a mask library, or during a scan. In general, movement of the object tables/holders MT and WT will be realized with the aid of a long-stroke module (coarse positioning) and a short-stroke module (fine positioning), which form part of the positioning device PM and PW. However, in the case of a stepper (as opposed to a scanner) the support structure MT may be connected to a short stroke actuator only, or may be fixed. Patterning device MA and substrate W may be aligned using patterning device alignment marks M1, M2 and substrate alignment marks P1, P2.

The depicted apparatus can be used in the following preferred modes:
1. In step mode, the support structure MT and the substrate holder WT are kept essentially stationary, while an entire pattern imparted to the beam PB is projected onto a target portion C in one go (i.e. a single static exposure). The substrate holder WT is then shifted in the X and/or Y direction so that a different target portion C can be exposed. In step mode, the maximum size of the exposure field limits the size of the target portion C imaged in a single static exposure.
2. In scan mode, the support structure MT and the substrate holder WT are scanned synchronously while a pattern imparted to the beam PB is projected onto a target portion C (i.e. a single dynamic exposure). The velocity and direction of the substrate holder WT relative to the support structure MT is determined by the (de-) magnification and image reversal characteristics of the projection system PL. In scan mode, the maximum size of the exposure field limits the width (in the non-scanning direction) of the target portion in a single dynamic exposure, whereas the length of the scanning motion determines the height (in the scanning direction) of the target portion.
3. In another mode, the support structure MT is kept essentially stationary holding a programmable patterning device, and the substrate holder WT is moved or scanned while a pattern imparted to the beam PB is projected onto a target portion C. In this mode, generally a pulsed radiation source is employed and the programmable patterning device is updated as required after each movement of the substrate holder WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

As briefly discussed above, for some applications there has been an increasing trend towards the use of line and space patterns for creating functional layers or features on a substrate. Line and space patterns usually refer to patterns which comprise a regular array of lines and spaces, which may be interpreted as regions that have been exposed and have not been exposed to radiation. However, in the context of the description of this invention, the line and space pattern is also used to describe a subtle variation on this more general concept, wherein gaps are provided in the lines to sever those lines (for functional or other reasons).

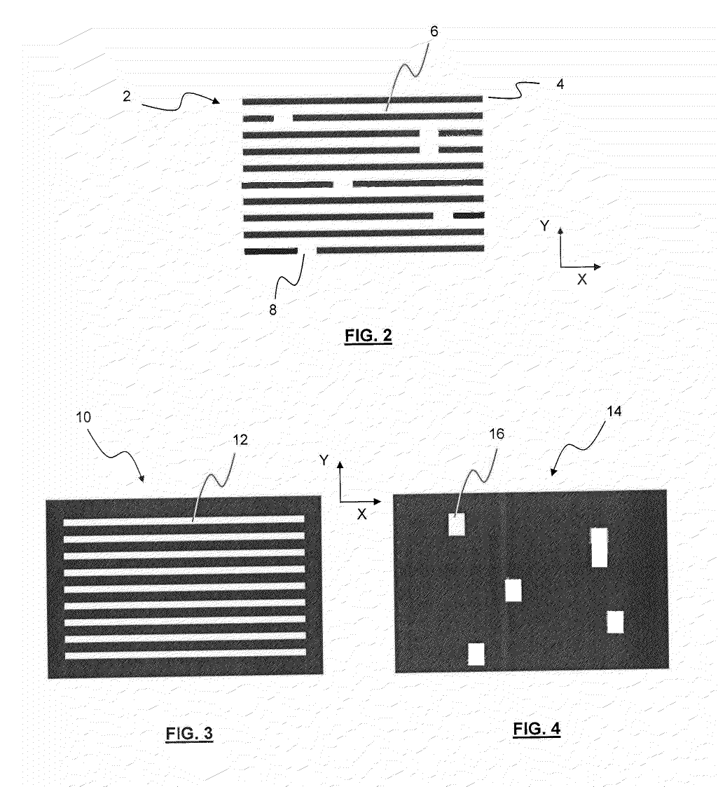

FIG. 2 schematically depicts an example of a line and space pattern 2 provided on a substrate (not shown). The line and space pattern 2 comprises a plurality of lines 4 that protrude from the substrate, and a number of spaces 6 (which may be described as trenches or recesses) in-between those lines 4. Otherwise continuous lines 4 are provided with gaps 8 which sever the respective line 4. Lines 4 may be provided with one or more gaps 8, as and where required. Depending on the tone of the resist used in the lithographic process, the lines 4 which protrude from the substrate may be regions that were exposed to radiation during the lithographic process, or may conversely be lines that were not exposed to radiation during the lithographic process, as will be understood by one skilled in the art.

The Figures also show directions X and Y. The directions are shown in all Figures to assist the understanding of the conventional lithographic process and also the lithographic apparatus, method and illumination mode according to embodiments of the invention. Conventionally, the pattern shown in FIG. 2 would be produced using two exposures and using two different patterning devices (i.e., masks or reticles), or patterning devices in different configurations.

FIG. 3 shows that a first patterning device 10 providing lines 12 may be used to provide the lines shown in the pattern of FIG. 2. In a different, subsequent exposure.

FIG. 4 shows that a second, different patterning device 14 may be provided with gaps 16 for use in providing the gaps in the lines as shown in and described with reference to the pattern of FIG. 2. The use of two exposures and two patterning devices (or a single device in a different configuration), is cumbersome, slow and generally undesirable. Valuable time is required to load and unload the different patterning devices, or to change the configuration of those patterning devices. Perhaps more significantly, valuable time is taken in undertaking the two exposures to provide the required line and space pattern. Both of these problems can lead to a reduction in throughput, and can also lead to problems with overlay or the like.

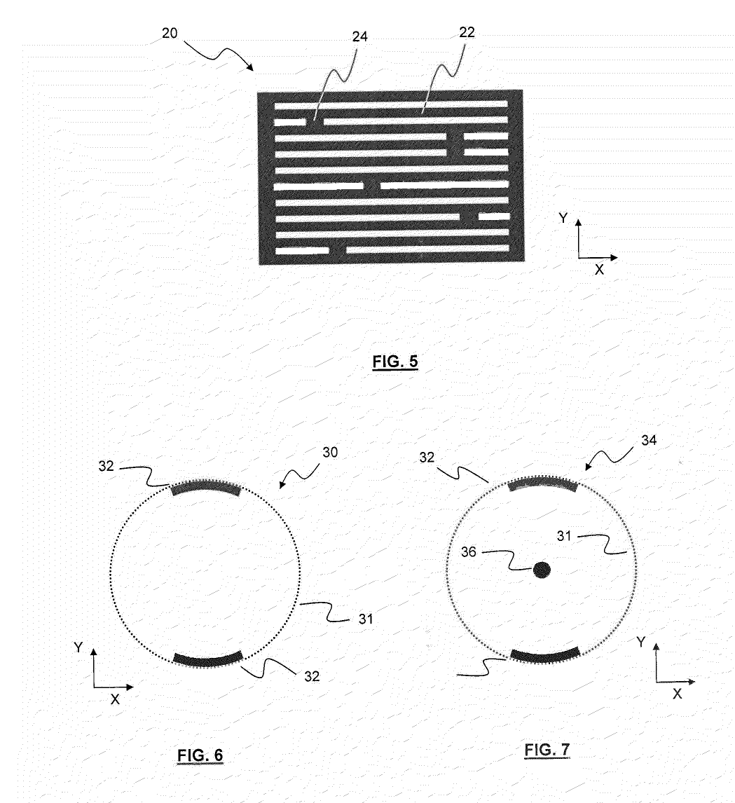

It has been proposed to overcome at least some of the problems discussed above by providing the required line and space pattern using only a single patterning device, and using only a single exposure. FIG. 5 schematically depicts a typical patterning device 20 that has been proposed, which provides a pattern that is a combination of the patterns of the devices of FIGS. 3 and 4. The patterning device 20 provides lines 22 and gaps or the like 24 for providing the lines and gaps discussed above in relation to the pattern of FIG. 2. An aim, at least in one embodiment, is to provide the pattern of FIG. 2, using only a single exposure with the patterning device 20 of FIG. 5, with the resulting pattern being generally acceptable (e.g., in terms of contrast and the like).

FIG. 6 shows a first illumination mode 30 that has been proposed for use in applying the pattern of FIG. 5 to a substrate. An intensity distribution of the illumination mode is shown in a pupil plane, for example a pupil playing of an illuminator (e.g. of the lithographic apparatus of FIG. 1, or for example in an other pupil playing of the lithographic apparatus). The dotted circle 31 shows the boundary where sigma is equal to 1. Within this boundary, the intensity distribution equates to a bright field intensity distribution (i.e., bright field illumination). Outside of this sigma equals 1 boundary (i.e. where sigma is greater than 1) the radiation would constitute dark field radiation or illumination. The significance of this will be discussed in more detail below with reference to embodiments of the invention.

The illumination mode 30 is a bright field dipole 32 illumination mode (i.e. the radiation falling within the sigma=1 boundary 31. The dipole 32 is oriented in the Y-direction, which is perpendicular to the lines of the pattern (shown in FIG. 5 extending in the X-direction) to be imaged onto the substrate. This particular relationship between the orientation of the dipole 32 and the lines of the pattern has been found to be give a good contrast along the edges of the length of the lines. However, a disadvantage with this illumination mode is that gaps in the lines, which are generally more isolated, or which have a greater pitch than the lines, and which have edges oriented in the perpendicular direction to the length of the lines (i.e., in the Y-direction, perpendicular to the X-direction of the lines), are not imaged with good contrast.

FIG. 7 shows that the above problem may be at least partially overcome using a different illumination mode 32 which, in comparison with the illumination mode of FIG. 6, additionally includes a central bright field intensity region 36. While this central intensity region 36 does serve to increase the contrast of the gaps, the central intensity region 36 has the disadvantageous feature of reducing the contrast of the edges of the lines along the length of those lines.

In summary, even though it is possible in proposed techniques to image a line and space pattern (having gaps in those lines) using only a single patterning device and only a single exposure, the resulting pattern applied to the substrate is not satisfactory. In particular the contrast of the features applied to the substrate is not as desired. It is desirable to be able to apply such a pattern to a substrate, but without the aforementioned reduction in contrast, or at least without such a great reduction in contrast.

In accordance with the invention, the abovementioned problems may be obviated or mitigated. The invention provides a lithographic apparatus comprising: an illumination system for providing a radiation beam; a patterning device for imparting the radiation beam with a pattern in its cross-section; a substrate holder for holding a substrate; and a projection system for projecting the patterned radiation beam onto a target portion of the substrate. The invention is distinguished from the conventional approaches discussed above by ensuring that the lithographic apparatus is arranged, at least in use, to image a pattern onto the substrate using radiation having: a bright field intensity distribution in the first direction; and a dark field intensity distribution in a second direction, substantially perpendicular to the first direction. The dark field intensity distribution may also have components located away from that perpendicular direction but, in accordance with the invention, the dark field intensity distribution will always have a component perpendicular to the first direction. The radiation in the aforementioned distribution might conveniently be provided in a single exposure.

In a preferred embodiment, the aforementioned intensity distribution is achieved by using the illumination system to provide, at least in use, and in a single exposure, an illumination mode which includes a radiation having a bright field intensity distribution in the first direction; and a dark field intensity distribution in the second direction. For an illumination mode, the described intensity distributions may describe the distributions within or at a pupil plane (e.g. of an illuminator, of an illuminator of a lithographic apparatus, or of a lithographic apparatus in general).

As will be discussed and explained in more detail below, the use of dark field radiation is particularly advantageous, especially when this radiation is distributed in a perpendicular direction to the bright field radiation. While the invention is particularly suited to the imaging of line and space patterns, as will be discussed below, such a radiation distribution might have other uses as might be apparent to the skilled person when reading this disclosure.

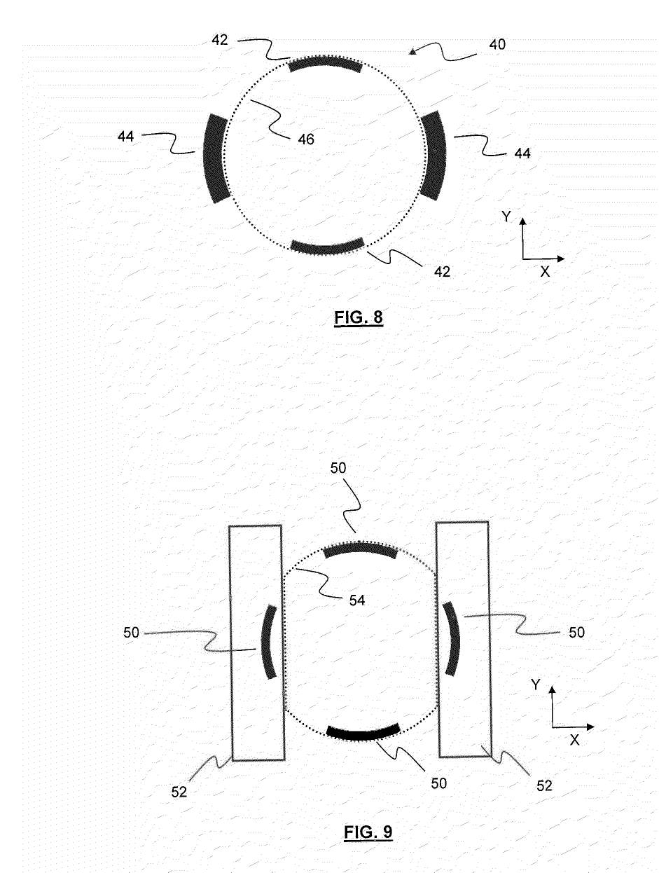

Embodiments of the invention will now be described with reference to FIGS. 8 to 10. FIG. 8 schematically shows an illumination mode in accordance with an embodiment of the invention. The illumination mode 40 is similar to the illumination mode shown in and described with reference to FIG. 6, in that the illumination mode 40 comprises a bright field dipole 42 oriented in a first direction (in the Y-direction in this embodiment). Again, this bright field dipole 42 is aligned in a direction substantially perpendicular to the direction in which the lines of the pattern shown in FIG. 5 extend (i.e., perpendicular to the X-direction) to give good contrast in the imaging of the long edges of those lines. In addition to the bright field dipole 42, there is provided in accordance with the invention a dark field dipole 44 (located outside of the sigma=1 boundary 46) that is aligned in a second direction, substantially perpendicular to the first direction (i.e., the dark field dipole 44 is aligned in the X-direction in this embodiment).

When using the intensity distribution of FIG. 8 to image and apply the pattern of FIG. 5 to a substrate, the particulars of the illumination mode and the associated advantages become clear. As already discussed above in the conventional approach, the bright field dipole 42 is particularly suited to the imaging of features which extend substantially perpendicular to the orientation of that dipole 42. This means that the lengths of the lines of the pattern are imaged well, and with good contrast. The dark field dipole 44, at the same time, and in the same exposure, does not scatter or diffract or the like off the long edges of the lines. Because of this, the dark field radiation does not contribute to the imaging of those lines on the substrate, and thus does not reduce or affect the contrast of the edges of the length of those lines. However, since the gaps in the lines are one or more of:
1) longer than a width of each of one or more of the lines; and/or
2) have a larger pitch and/or are more isolated features than the one or more lines; and/or
3) have a component which extends perpendicularly with respect to the direction of alignment of the dark field dipole (i.e., the gap edges extending in the Y-direction, the dark field dipole extending in the X-direction),
   the dark field radiation is scattered or diffracted or the like to result in the gaps in the lines being imaged with good contrast by the dark field radiation. The result is that, in a single exposure, both the lines and the gaps are resolved and imaged with good contrast.

The above may be functionally described as a patterning device providing one or more lines having one or more dimensions and/or orientations which result in the one or more lines being imaged, in use, substantially only by the bright field radiation, and wherein the patterning device provides one or more gaps in those lines having one or more dimensions and/or orientations which result in the one or more gaps being imaged, in use, substantially only by the dark field radiation.

One disadvantage of the use of dark field illumination is that such illumination is not photon effective. However, this can be compensated for by ensuring that the dark field intensity distribution has a higher overall intensity than the bright field intensity distribution, or compensated for in some other way. The advantages, however, are numerous. Perhaps most importantly, a line and space pattern can be imaged with good contrast using only a single exposure. This overcomes the problems discussed above in connection with conventional approaches where multiple patterning devices and multiple exposures are required, or where inadequate bright field illumination modes in a single exposure result in poor contrast.

The required intensity distributions may be established using an illuminator of the lithographic apparatus. A standard illuminator might require some modification or re-design to allow for the generation of the dark field illumination (e.g. to generate and/or accommodate the wider propagation angles of the dark field radiation relative to the optical axis, in comparison with bright field radiation). However, this might simply require the illuminator to be bigger than is currently standard, or elements thereof to operate function at different angles, and would not require any inventive capability or the like to implement.

FIG. 9 shows a different approach for employing dark field generation, which might not require a re-design of the illuminator. A bright field quadruple illumination mode 50 is provided. A patterning device may be illuminated with this quadruple illumination mode 50, for example the patterning device shown in FIG. 5 having the line and space pattern. Thus, at the patterning device, no dark field radiation is incident on that patterning device. Located downstream of the patterning device, and before or forming part of the projection system, is a mask arrangement 52. The mask arrangement 52 is configured to mask at least a portion (e.g., a dipole of) the illumination mode 52, for example the dipole oriented in the X-direction (perpendicular to the direction of extension of the lines of the pattern of FIG. 5). This masking artificially re-defines the sigma=1 (i.e., the bright field to dark field) boundary 54 for the projection system. Bright field radiation that was incident on the patterning device is unable to pass though the projection system and on to the substrate. Instead, by masking out the bright field radiation oriented in the X-direction, the only radiation in the X-radiation that can reach the substrate would be radiation that has scattered or diffracted or the like off pattern features, and which is no longer bright field radiation. In other words, the only radiation from the masked bright field dipole that can reach the substrate is dark field radiation. The dark field radiation would only have resulted from scattering of certain pattern features (e.g., the gaps described above and not the lines described above), thus leading to the advantages discussed above.

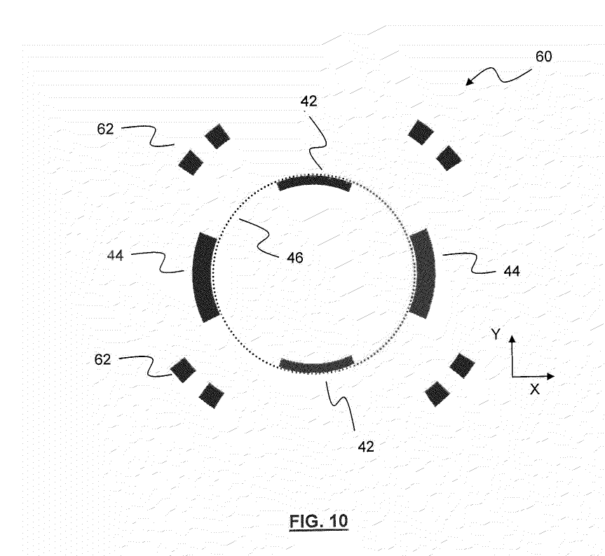

As described above, the dark field intensity distribution may also have components located away from that perpendicular direction, for example to assist in imaging, but, in accordance with the invention, the dark field intensity distribution will always have a component perpendicular to the first direction. FIG. 10 shows an example of an illumination mode 60 similar to that shown in and described with reference to FIG. 8. However, FIG. 10 shows that additional dark field components 62 have been provided, in a more freeform illumination mode.

Regarding the photon ineffectiveness discussed above, it may be advantageous to use an attenuated phase shift mask (or, more generally, an attenuated phase shift patterning device). In attenuated phase shift masks there is less power in the 0th order (the order that is blocked for dark field illumination) relative to the higher orders. Or, in other words, more power is present in the higher orders. This compensates for the photon ineffectiveness.

In above embodiments, the term ‘gap’ has been used. This term is to be construed broadly. In some instances, gaps in an imaged line might in fact correspond to an absence of a gap at the patterning device (e.g. where radiation is prevented from passing on to the projection system), or vice versa (depending on the tone of the resist).

In the above embodiments, radiation having a bright field intensity distribution in a first direction and a dark field intensity distribution in second direction, substantially perpendicular to the first direction, has been described as being used in a single exposure to image a pattern on to a substrate. This is advantageous, since only a single exposure is required, which might result in savings in terms of time, cost, processes, and throughput. However, the described radiation may be used in different exposures, for example consecutive exposures. More specifically, radiation having a bright field intensity distribution in a first direction and a dark field intensity distribution in second direction, substantially perpendicular to the first direction, might be provided in each of two different exposures. Many of the advantages described above might still be present in connection with such an embodiment, with the exception of any advantages associated solely with the use of a single combined exposure (or illumination mode).

The dark field radiation described above is particularly advantageous, for the reasons given. In another embodiment, bright field radiation may be altogether disposed of, and dark field radiation alone used to apply a pattern to a substrate. For example, dark field c-quad (quadrapole) illumination may be used to provide all of the pattern features (e.g. lines extending on first (e.g. X) and second, perpendicular (e.g. Y) directions, the nature of dark field illumination ensuring good contrast for edges of those lines, and any gaps in those lines. Again, there might be disadvantages with this approach in terms of the dark field radiation not being photon effective, which might however be overcome by using a more sensitive resist or a higher dose of radiation.

While specific embodiments of the invention have been described above, it will be appreciated that the invention may be practiced otherwise than as described. The description is not intended to limit the invention, the invention instead being limited by the claims that follow.

It is to be appreciated that the Detailed Description section, and not the Summary and

Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A lithographic apparatus comprising:
an illumination system configured to provide a radiation beam;
a patterning device configured to impart the radiation beam with a pattern in its cross-section;
a substrate holder configured to hold a substrate; and
a projection system configured to project the patterned radiation beam onto a target portion of the substrate,
wherein the lithographic apparatus is constructed and arranged, at least in use, to image a pattern on to the substrate using radiation having:
a bright field intensity distribution in a first direction; and
a dark field intensity distribution in second direction, substantially perpendicular to the first direction.

2. The lithographic apparatus of claim 1, wherein the illumination system is configured to provide, at least in use, an illumination mode, the illumination mode comprising radiation having:
a bright field intensity distribution in the first direction; and
a dark field intensity distribution in the second direction.

3. The lithographic apparatus of claim 1, wherein the patterning device is configured to provide a substantially line and space pattern to be imaged on the substrate, one or more lines having one or more gaps therein that each sever the line.

4. The lithographic apparatus of claim 3, wherein the one or more lines extend along the second direction.

5. The lithographic apparatus of claim 3, wherein the patterning device is configured such that the one or more gaps are each longer than a width of each of the one or more lines.

6. The lithographic apparatus of claim 3, wherein the patterning device is configured such that the one or more gaps have a larger pitch and/or are more isolated features than the one or more lines.

7. The lithographic apparatus of claim 3, wherein the patterning device provides:
one or more lines having one or more dimensions and/or orientations which result in the one or more lines being imaged, in use, by the bright field radiation, and
one or more gaps having one or more dimensions and/or orientations which result in the one or more gaps being imaged, in use, by the dark field radiation.

8. The lithographic apparatus of claim 3, wherein the patterning device provides:
one or more lines having one or more dimensions and/or orientations which result in the one or more lines being imaged, in use, substantially only by the bright field radiation, and
one or more gaps having one or more dimensions and/or orientations which result in the one or more gaps being imaged, in use, substantially only by the dark field radiation.

9. The lithographic apparatus of claim 1, wherein the dark field intensity distribution has a higher intensity than the bright field intensity distribution.

10. The lithographic apparatus of claim 2, wherein:
the bright field intensity distribution configured to form at least a dipole; and/or
the dark field intensity distribution configured to form at least a dipole.

11. The lithographic apparatus of claim 1, further comprising a mask arrangement located downstream of the patterning device, the mask arrangement being configured to mask at least a portion of bright field radiation distributed in the first direction, to ensure that there is dark field radiation distributed in the first direction.

12. The lithographic apparatus of claim 1, wherein the patterning device comprises, or is, an attenuated phase shift patterning device.

13. A lithographic method, the method comprising:
imaging a pattern on to a substrate using radiation having:
a bright field intensity distribution in a first direction; and
a dark field intensity distribution in a second direction, substantially perpendicular to the first direction.

14. The lithographic method of claim 13, wherein the bright field intensity distribution is in the first direction, and the dark field intensity distribution is in the second direction, in a pupil plane.

15. An illumination mode, the illumination mode comprising radiation having:
a bright field intensity distribution in a first direction; and
a dark field intensity distribution in a second direction, substantially perpendicular to the first direction.

16. The illumination mode of claim 15, wherein the bright field intensity distribution is in the first direction, and the dark field intensity distribution is in the second direction, in a pupil plane.
